(19) United States
(12) Patent Application Publication
(10) Pub. No.: US 2024/0421438 A1
(43) Pub. Date: Dec. 19, 2024

(54) Battery Pack, System and Method

(71) Applicant: Andreas Stihl AG & Co. KG, Waiblingen (DE)

(72) Inventors: Daniel SAUERTEIG, Kernen im Remstal (DE); Joachim KOLB, Ludwigsburg (DE)

(21) Appl. No.: 18/741,919

(22) Filed: Jun. 13, 2024

(30) Foreign Application Priority Data
Jun. 14, 2023 (EP) 23179158.3

(51) Int. Cl. H01M 50/503; B29C 45/14; B29L 31/34; H01M 50/204; H01M 50/583

(52) U.S. Cl. CPC H01M 50/503; B29C 45/14639; H01M 50/204; H01M 50/583; B29K 2995/0007; B29L 2031/3406; H01M 2200/103; H01M 2220/30

(57) ABSTRACT

A battery pack for a battery device has a battery cell pack, a connection device and an electrical busbar unit electrically connecting the battery cell pack to the connection device. The busbar unit has an electrically conductive core body and an electrically insulating stabilization body made of electrically insulating material. The core body has a first embedded portion, which is nearer the connection device, and a second embedded portion, which is remote from the first embedded portion. The core body has a fusible link portion of reduced cross section relative to the two embedded portions, which fusible link portion electrically and mechanically connects the two embedded portions to one another. The two embedded portions are each embedded in the electrically insulating material of the stabilization body. The stabilization body has at least one bridge portion, which extends at a spacing from the fusible link portion between the two embedded portions, in order to mechanically support the two embedded portions with respect to one another in addition to their connection by way of the fusible link portion.

### CROSS REFERENCE TO RELATED APPLICATION

This application claims priority under 35 U.S.C. § 119 from European Patent Application No. 23179158.3, filed Jun. 14, 2023, the entire disclosure of which is herein expressly incorporated by reference.

### BACKGROUND AND SUMMARY

The invention relates to a battery pack for a battery device, in particular a working tool or charging device, an adapter device, or a battery transport device. The invention also relates to a system comprising such a battery device and such a battery pack. The invention furthermore relates to a method for producing a busbar unit for such a battery pack.

An object of the invention is to provide a battery pack for a battery device, in particular a working tool or charging device, an adapter device, or a battery transport device, a system comprising such a battery device and such a battery pack, and a method for producing a busbar unit for such a battery pack, which have improved properties.

This object is achieved by the subjects of the independent patent claims. The dependent patent claims relate to preferred embodiments.

A battery pack according to the invention is intended for use together with a battery device, in particular a working tool or charging device, an adapter device, or a battery transport device. The battery device, in particular if it is a working tool, may be electrically operated using energy from the battery pack. Correspondingly, the battery device may be synonymously referred to as a battery-operable or a battery-operated device. The battery pack comprises a battery cell pack for storing electrical energy. The battery pack also has a connection device for electrically connecting the battery pack to the battery device. Furthermore, the battery pack has at least one, for example exactly one or more than one, electrical busbar unit, which electrically connects the battery cell pack to the connection device. The busbar unit has an electrically conductive core body and an electrically insulating stabilization body, the electrically insulating stabilization body comprising an electrically insulating material or consisting of such an electrically insulating material. The core body has a first embedded portion, which is nearer the connection device, and a second embedded portion, which is remote from the first embedded portion. Furthermore, the core body has an in particular integral fusible link portion of reduced cross section relative to the two embedded portions. The fusible link portion electrically and mechanically, i.e. in particular physically, connects the two embedded portions to one another. The two embedded portions are each embedded in the electrically insulating material of the stabilization body. In this context, “embedded” can mean that the embedded portions in the electrically insulating material are completely surrounded along a peripheral direction of the busbar unit. The stabilization body also has at least one bridge portion, which extends at a spacing from the fusible link portion between the two embedded portions. By means of the bridge portion, the two embedded portions are, in addition to their connection by way of the fusible link portion, mechanically, i.e. in particular physically, supported with respect to one another. Advantageously, the busbar unit has proven to be mechanically particularly stable in spite of the thinner fusible link portion, and this can make it easier to mount the battery pack according to the invention.

The electrical busbar unit can be electrically connected to the battery cell pack by means of an openable electronic circuit breaker of the battery pack. The circuit breaker can be a component of power electronics of the battery pack. The embedded portions may be in direct, i.e. touching, contact with the material of the stabilization body. Correspondingly, the stabilization body may directly rest against the embedded portions. In particular, the stabilization body and the embedded portions are adhesively bonded and/or form-fittingly connected to one another. The fusible link portion may form an intended breaking point of the core body for automatically interrupting an electrical conduction path through the core body in the event of an overload. In particular, the fusible link portion is designed to automatically interrupt the conduction path in the event of an electrical current strength of 100 A (amperes) to 2000 A, in particular of approximately 150 A. The core body, apart from its fusible link portion, may have a conduction cross section, in particular in the embedded portions, which is greater than the conduction cross section in the fusible link portion. The conduction cross section may be reduced, in particular thinned, in the fusible link portion to 0.05 to 0.5 times, in particular to 0.1 times, the narrowest conduction cross section of the core body outside, or apart from, the fusible link portion. The narrowest conduction cross section of the core body outside the fusible link portion may be 2.4 mm² (square millimetres) to 30 mm², in particular 10 mm².

Expediently, the battery pack is rechargeable or not rechargeable. If the battery pack is rechargeable, the battery pack may be an accumulator pack. In this case, the battery cell pack may be an accumulator cell pack.

The accumulator-powered device in the form of a working tool may be ground-guided and/or hand-operated, in particular hand-held, and/or worn on the back and/or a gardening, forestry, cultivation and/or construction tool. In particular, the working tool may be a saw, in particular a chainsaw, or a pruner, or a hedge trimmer, or a hedge cutter, or a wood cutter, or pruning shears, an angle grinder or a blower, or a leaf blower, or a vacuum cleaner, or a leaf vacuum, or a cleaning appliance, or a high-pressure cleaner, or a sweeper, or a sweeper roller, or a sweeping brush, or a lawnmower, or a grass trimmer, or a brush cutter, or a scarifier. In addition or as an alternative, the working tool may have a working implement and/or an in particular electric drive motor, in particular for driving the working implement.

It can be possible to supply electrical energy to the drive motor from the battery pack.

The electric tool in the form of a charging device can have a grid connection for electrical connection to an electrical energy source, for example to an electrical supply grid. The charging device may be used to charge the battery pack with electrical energy.

The battery device in the form of an adapter device may be designed to receive the battery pack. In this case, the adapter device itself can be connected to a superordinate battery device, so that the battery pack is electrically connected to the superordinate battery device by means of the adapter device. In this respect, the adapter device can act as a battery adapter for exchangeable mechanical and/or electrical coupling of the battery pack to the superordinate battery device.

The battery device in the form of a battery transport device may be designed to transport the battery pack. The battery transport device may be configured for, in particular detachable, electrical connection of an electrical load to a battery pack received by the battery transport device. In this case, the battery transport device may have at least one electrical output connection for connecting an electrical load, the output connection being electrically connectable or connected to the received battery pack, in order to supply electrical energy to the attached load from the battery pack. As an alternative, the battery transport device may be configured to electrically insulate the received battery pack.

The battery device, in particular in the form of a working tool or charging device or adapter device or battery transport device, may be designed to be worn on the back. If the battery device is designed to be worn on the back, at least one receiving device of the battery device for receiving the battery pack may be configured to be worn on a user's back. To this end, the battery device may comprise a harness, which is designed for a user to wear the receiving device. The harness may have at least one shoulder strap and/or waist strap and/or chest strap.

The battery pack may be designed for user-detachable mechanical connection, in particular without tools and/or non-destructively, to the battery device and/or be exchangeable by the user or removable by the user, in particular from or out of the battery device. In particular, the battery pack may be designed to be carried by the battery device. The battery cell pack may comprise multiple battery cells. In particular, the battery cells may be arranged in a pack housing of the battery pack. In addition or alternatively, the battery cells may be electrochemical-based electrical energy storage elements. As another addition or alternative, the battery cells may be lithium-ion accumulator cells. As another addition or alternative, the battery cells may be identical, in particular of the same type and/or construction. As another addition or alternative, an in particular respective cell voltage, in particular cell rated voltage, of an in particular respective one of the battery cells may be at least 2 V (volts), in particular at least 3.6 V, and/or at most 5 V, in particular at most 4.2 V. As another addition or alternative, the battery cells may be round cells, prismatic cells or pouch cells. The battery cells may be designed to supply the battery device with electrical drive power and/or be able to be supplied with electrical charge power by means of the battery device.

The term “configured” may be used synonymously for the term “designed”.

The term “comprises” may be used synonymously for the term “has” or “contains”.

“Arranged” may be spatially and/or fixedly arranged, in particular fastened, in particular in stationary fashion. In addition or as an alternative, the term “positioned” may be used synonymously for the term “arranged”.

In one configuration of the invention, an electrically conductive material of the core body is bare at its fusible link portion. In this case, the core body is in particular in the form of a sheet-metal part, in particular wherein its material is or comprises a copper sheet. The core body may thus comprise a copper sheet or consist of a copper sheet. In the present context, “bare” can mean that there is no contact with another body, in particular no contact with the stabilization body. The copper sheet may comprise or consist of a copper alloy. The copper alloy may comprise at least 50 wt. % (percent by weight) Cu. The copper sheet may be tin-plated.

Expediently, a cross section of the core body outside the fusible link portion substantially corresponds to a rectangle with a first side length of from 0.3 mm (millimetres) to 1.0 mm and a second side length of from 8 mm to 30 mm. An aspect ratio of the rectangle may be 3 to 4.

In another configuration of the invention, the core body longitudinally extends from its first embedded portion to its second embedded portion along a longitudinal direction of the busbar unit. The core body extends transversely to the longitudinal direction along a width direction of the busbar unit. The core body has an in particular uniform core thickness perpendicular to the longitudinal direction and perpendicular to the width direction. In particular, the core thickness is 0.3 mm to 1.0 mm, in particular 0.5 mm. In this way, it is possible to provide a sufficiently large conduction cross section combined while at the same time maintaining a sufficiently flat structure of the busbar unit.

In another configuration of the invention, the busbar unit is at least partially flat and/or planar and at least partially rests against the battery cell pack. This advantageously results in a battery pack with a particularly compact structure.

Expediently, the battery pack has a substantially cylindrical, in particular prismatic, in particular cuboidal shaping. The longitudinal direction may extend from a round or polygonal bottom side to a top side, situated opposite the bottom side, of the battery pack. The bottom side and/or the top side may, for example, be triangular or rectangular or octagonal. A maximum width of the busbar unit is in particular smaller than the width of one side of the battery cell pack on which the busbar unit is arranged.

In another configuration of the invention, the stabilization body has a thickness perpendicular to the longitudinal direction and perpendicular to the width direction. The thickness is 1 to 5 times, in particular 3 times, the core thickness. A layer thickness of the material of the stabilization body on the embedded portions of the core body may be approximately the same as the core thickness in absolute terms. In the bridge portion, the thickness corresponds to a material thickness and in the embedded portions it is composed of the core thickness and twice the layer thickness.

In another configuration of the invention, the stabilization body has two bridge portions, which are situated opposite one another along the width direction of the busbar unit, in order to flank the fusible link portion at a mutual spacing. The fusible link portion connects the two embedded portions to one another transversely, in particular perpendicularly, to the width direction. The fusible link portion may have a length of from 5 to 30 mm, for example 23 mm. A transition between a respective one of the embedded portions and the fusible link portion may be rounded. The material of the core body may be bare at the transition. The core body may accordingly have a region in which the material of the core body is bare and which comprises the transitions and the fusible link portion. The region may have a length of from 6 to 35 mm, for example 25 mm. The region may have a width of from 3 to 10 mm, for example 5 mm.

Expediently, the busbar unit at least partially has a substantially straight and/or curved shaping.

Expediently, the fusible link portion extends substantially in a straight line. As an alternative, the fusible link portion may, however, also have a sinuous, wavy and/or S-like shaping. There may be multiple fusible link portions, which are arranged at a spacing from one another and together mechanically connect the embedded portions to one another electrically in parallel.

In another configuration of the invention, at least one, in particular each, of the embedded portions has at least one in particular lug- or tongue-shaped projection. This projection protrudes into an intermediate space of the core body, which intermediate space is present between the embedded portions and extends along the fusible link portion. In particular, the at least one, in particular each, of the embedded portions has two such projections, which are situated opposite one another along the width direction of the busbar unit. The embedded portions may act as a heat sink. The projection may enhance the aforementioned heat sink function. In addition, the projection, as component of the respective embedded portion, may be embedded in the material of the stabilization body, so that a distance to be spanned by the bridge portion between the embedded portions can be reduced by means of the projection. In this respect, the projection may enhance the support of the embedded portions with respect to one another that is brought about by the bridge portion.

In a further configuration of the invention, in the region of at least one of the two embedded portions, the busbar unit has a pair of positioning projections, which are situated opposite one another along the width direction of the busbar unit. In particular, the positioning projections are configured to align the busbar unit and/or fix it in place relative to the battery cell pack and/or relative to the connection device. The alignment and/or fixing in place by means of the positioning projections can be effected when the busbar unit is joined to the battery cell pack and/or the connection device to produce the battery pack. As an alternative or in addition, the positioning projections may serve to align the busbar unit relative to an apparatus, which apparatus can be used for pre-mounting.

In a further configuration of the invention, a first contact portion, adjoining the first embedded portion, of the core body is integrally bonded, in particular welded or soldered, to the connection device. As an alternative or in addition, a second contact portion, adjoining the second embedded portion, of the core body is integrally bonded, in particular welded or soldered, to the battery cell pack or to power electronics of the battery pack that are electrically connected to the battery cell pack. The contact portions may be angled relative to the longitudinal direction, in order to engage around the battery cell pack, in particular at the top and the bottom. In this way, a particularly reliable connection can be achieved, in particular to comply with standards. It is also possible to particularly reliably ensure current-carrying capacity in this way. Moreover, the integral bond can make it more difficult to prematurely and/or incorrectly repair the battery pack in the event of the fusible link portion melting through or burning through previously.

In a further configuration of the invention, the electrically insulating material of the stabilization body is or comprises an in particular flame-retardant plastic. As an alternative or in addition, the two embedded portions are peripherally coated with the plastic to embed them. As an alternative or in addition, the stabilization body forms an injection-moulded encapsulation of the busbar unit, which injection-moulded encapsulation surrounds the embedded portions of the core body.

The embedded portions may be peripherally coated with the plastic along the peripheral direction of the busbar unit. The peripheral direction may extend in a plane stretching out perpendicularly in relation to the longitudinal direction. A thickness direction of the busbar unit may extend perpendicularly in relation to the longitudinal direction and perpendicularly in relation to the width direction.

At least one main component of the plastic may be selected from the group of polybutylene terephthalate (PBT), polyamide (PA) and polypropylene (PP). The plastic may be reinforced with glass fibers. For example, the plastic may comprise 20 to 40 wt. % glass fibers. PBT GF 30, a polybutylene terephthalate with a glass fiber content of 30 wt. %, has proven to be particularly suitable. This is because PBT GF 30 can be readily processed and can moreover comply with standards regarding flame protection particularly well.

In a further configuration of the invention, the bridge portion projects away from the fusible link portion along the width direction of the busbar unit, in particular by a magnitude of the free spacing present along the width direction between the fusible link portion and the bridge portion. The free spacing may be 1 to 10 mm, for example 1.5 mm.

In a further configuration of the invention, the battery pack has two busbar units, which in particular have the same construction and in particular are arranged on opposite sides of the battery pack. In particular, the two busbar units flank the battery cell pack. The battery cell pack can be electrically connected to the connection device, in particular pole by pole, by means of the two busbar units. As an alternative or in addition, the battery pack has an additional electrical fuse device that is redundant with respect to the fusible link portion, in particular wherein the additional electrical fuse device has an electronic circuit breaker.

The system according to the invention comprises a battery device, in particular a working tool or charging device, an adapter device, or a battery transport device. In addition, the system comprises at least one battery pack according to the invention as described above. In this respect, the advantages of the battery pack that were cited above can also be transferred to the system according to the invention. In particular, the battery pack is electrically connected exchangeably to the battery device, in order to supply electrical energy to the battery device and/or draw electrical energy from the battery device.

A method according to the invention can be used to produce a busbar unit for a battery pack according to the invention as described above. In this respect, the method according to the invention makes it possible to exploit the aforementioned advantages of the battery pack according to the invention. According to the method, the stabilization body is made around the core body by primary forming, in particular with or from plastic.

The busbar unit may be produced by encapsulating the core body by casting with casting resin for the stabilization body. As an alternative, to produce the busbar unit, the core body can be dipped into a rubber dip bath in order to form the stabilization body. As an alternative, it is also conceivable to produce, in particular injection mould, insulating parts for the stabilization body separately, and then adhesively bond them to one another to embed the core body.

In one configuration of the invention, the method comprises the steps set out below. According to step a), a closeable injection mould having a cavity is provided, wherein the cavity has a complementary negative contour to the shaping of the stabilization body. According to a further step b) of the method, the core body is positioned on and/or in the open injection mould. According to a further step c), the injection mould is closed, in order to arrange, in particular clamp, the core body inside the cavity of the injection mould in such a way that the fusible link portion is masked. According to a further step d), the stabilization body is injection moulded, wherein the core body, apart from its fusible link portion, is encapsulated with the material of the stabilization body by injection moulding, in order to embed the two embedded portions in the material of the stabilization body.

Expediently, temporally before step a) is carried out, it is possible to perform separating work, in particular punching, and/or shaping of the core body. As an alternative or in addition, the busbar unit can be subjected to shaping or separating machining temporally after carrying out step d).

Expediently, the battery pack according to the invention can be produced by electrically connecting its battery cell pack, or power electronics of the battery pack that are electrically connected to the battery cell pack, to the connection device of the battery pack by means of the busbar unit produced by the method.

Further advantages and features of the invention will emerge from the claims and from the following description of a preferred exemplary embodiment of the invention, which is depicted by the drawings. Reference numbers that are the same relate to components that are the same or similar or have the same function.

It should be understood that the features mentioned above and those yet to be explained below can be used not only in the respectively cited combination but also in other combinations or on their own without departing from the scope of the present invention.

Further advantages and features of the invention will emerge from the claims and from the following description of a preferred exemplary embodiment of the invention, which is depicted by the drawings. Reference numbers that are the same relate to components that are the same or similar or have the same function.

It should be understood that the features mentioned above and those yet to be explained below can be used not only in the respectively cited combination but also in other combinations or on their own without departing from the scope of the present invention.

### BRIEF DESCRIPTION OF THE DRAWINGS

FIG. 1 is a schematic side view of one embodiment of a system according to the invention with one embodiment of a battery pack according to the invention;

FIG. 2 is a schematic perspective depiction of the battery pack according to FIG. 1 with a busbar unit produced according to the invention;

FIG. 3 is a schematic perspective depiction of the busbar unit of the battery pack according to FIG. 2 separately;

FIG. 4 is a schematic perspective depiction, in section, of the busbar unit according to FIG. 3;

FIG. 5 is a schematic sectional depiction of the busbar unit according to FIGS. 3 and 4;

FIG. 6 is a schematic perspective depiction of a core body of the busbar unit according to FIGS. 3 to 5; and

FIG. 7 is a schematic perspective depiction of a stabilization body of the busbar unit according to FIGS. 3 to 5.

### DETAILED DESCRIPTION OF THE DRAWINGS

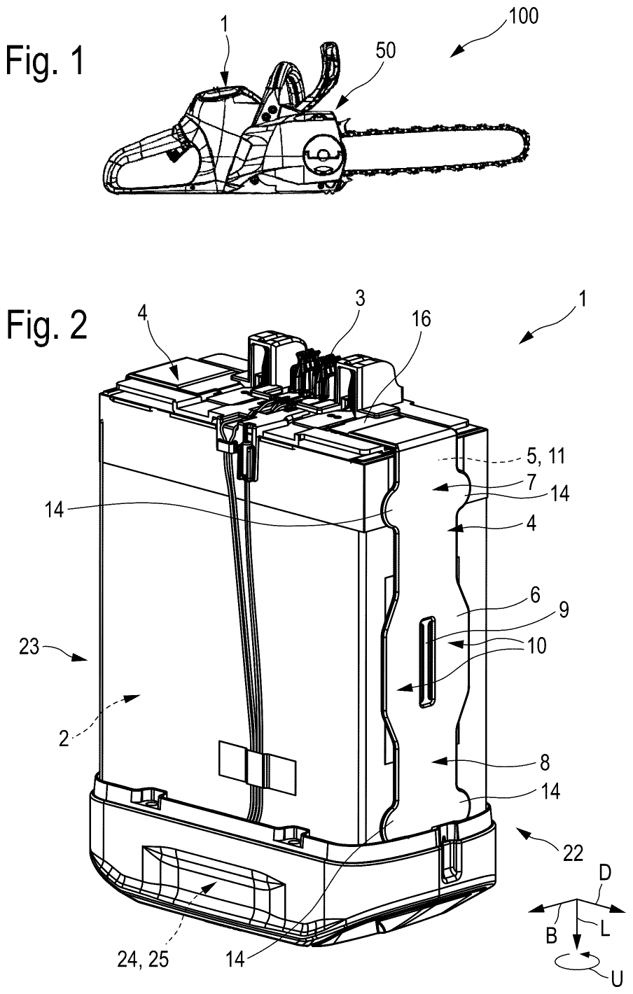

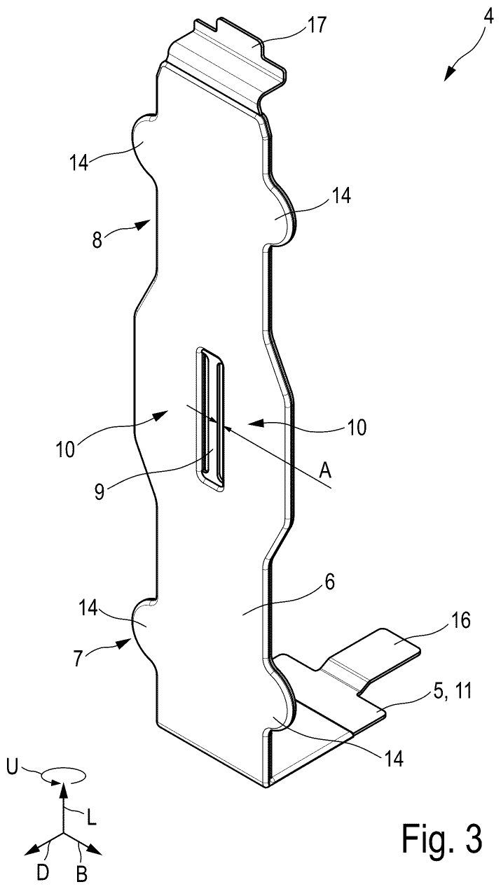

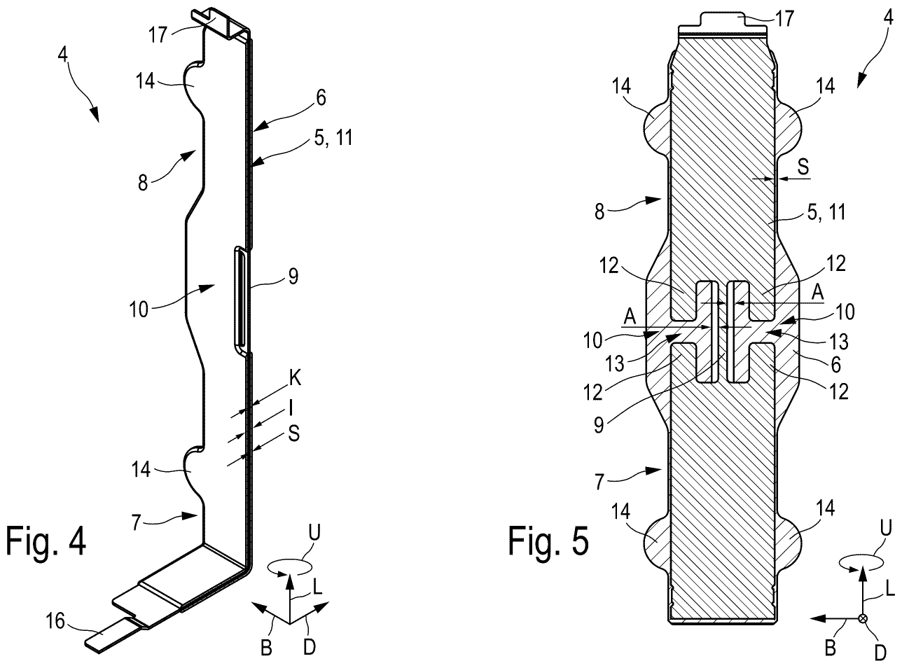

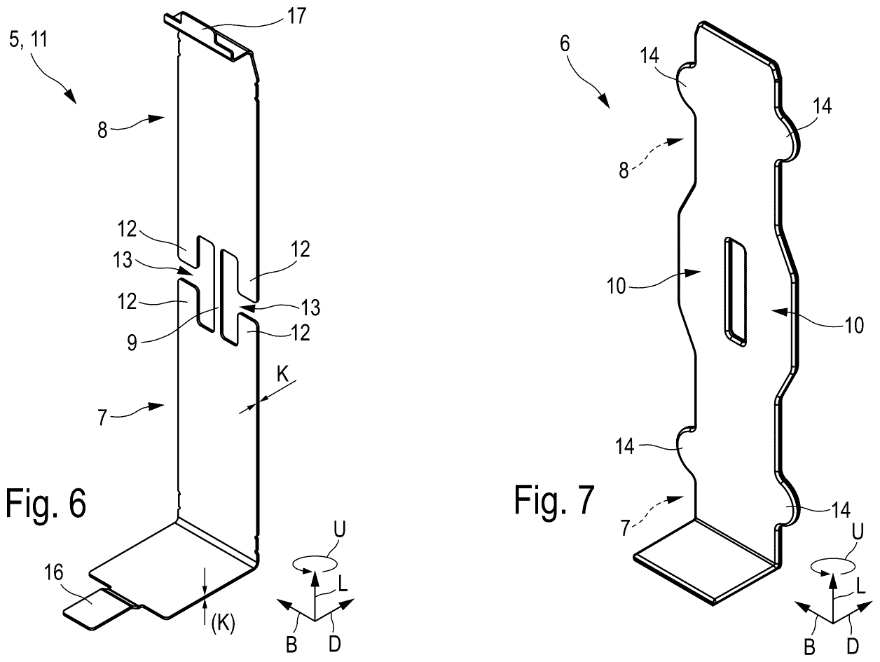

A system 100 comprises a battery device 50. The battery device 50 can be in the form of a working tool, a charging device, an adapter device, or a battery transport device. According to FIG. 1, the battery device 50 is in the form, for example, of a working tool, in the present case a chainsaw. The system 100 moreover has at least one battery pack 1. The battery pack 1 is electrically connected exchangeably, for example, to the battery device 50, in order to supply electrical energy to the battery device 50. As an alternative or in addition, the battery pack 1 may be electrically connected to the battery device 50, in order to draw electrical energy from the battery device 50.

The battery pack 1 comprises a battery cell pack 2 for storing electrical energy. The battery pack 1 also comprises a connection device 3 for electrically connecting the battery pack 1 to the battery device 50. Moreover, the battery pack 1 has at least one electrical busbar unit 4, which electrically connects the battery cell pack 2 to the connection device 3. In the present case, there are two electrical busbar units 4, which, for example, have the same construction. The two busbar units 4 are arranged on opposite sides 22, 23 of the battery pack 1, in order to flank the battery cell pack 2.

The busbar unit 4 has an electrically conductive core body 5 and an electrically insulating stabilization body 6 comprising or made of electrically insulating material. The core body 5 has a first embedded portion 7, which is nearer the connection device 3, and a second embedded portion 8, which is remote from the first embedded portion 7. The core body 5 also has a fusible link portion 9 of reduced cross section relative to the two embedded portions 7, 8, which fusible link portion electrically and mechanically connects the two embedded portions 7, 8 to one another. The two embedded portions 7, 8 are each embedded in the electrically insulating material of the stabilization body 6. The stabilization body 6 has at least one bridge portion 10, which extends at a spacing A from the fusible link portion 9 between the two embedded portions 7, 8, in order to mechanically support the two embedded portions 7, 8 with respect to one another in addition to their connection by way of the fusible link portion 9.

The battery pack 1 may have an additional electrical fuse device 24 which is redundant with respect to the fusible link portion 9. The additional electrical fuse device 24 may comprise an openable electronic circuit breaker 25. The electrical busbar unit 4 can be electrically connected to the battery cell pack 2 by means of the circuit breaker 25 of the battery pack 1. The circuit breaker 25 can be a component of power electronics of the battery pack 1.

In the present case, the stabilization body 6 has two bridge portions 10, which are situated opposite one another along a width direction B of the busbar unit 4, in order to flank the fusible link portion 9 at a mutual spacing A. The fusible link portion 9 connects the two embedded portions 7, 8 to one another transversely, in particular perpendicularly, to the width direction B of the busbar unit 4. In the present case, the fusible link portion 9 is arranged between the two bridge portions 10 along the width direction B.

The embedded portions 7, 8 are in direct and/or touching contact with the material of the stabilization body 6, i.e. the stabilization body 6 rests directly against the embedded portions 7, 8. In particular, the stabilization body 6 and the embedded portions 7, 8 are adhesively bonded and/or form-fittingly connected to one another.

The fusible link portion 9, which is integral in the present case, forms for example an intended breaking point of the core body 5 for automatically interrupting an electrical conduction path through the core body 5 in the event of an overload. In particular, the fusible link portion 9 is designed to automatically interrupt the conduction path in the event of an electrical current strength of 100 A to 2000 A, in particular of approximately 150 A.

In the present case, the core body 5, apart from its fusible link portion 9, may have a conduction cross section, in particular in the embedded portions 7, 8, which is greater than the conduction cross section in the fusible link portion 9. The conduction cross section may be reduced, in particular thinned, in the fusible link portion 9 to 0.05 to 0.5 times, in particular to 0.1 times, the narrowest conduction cross section of the core body 5 outside, or apart from, the fusible link portion 9. The narrowest conduction cross section of the core body 5 outside the fusible link portion 9 may be 2.4 mm² to 30 mm², for example 10 mm².

The core body 5 comprises, for example, an electrically conductive material, which is bare at the fusible link portion 9. In this case, the core body 5 is for example in the form of a sheet-metal part 11, in particular wherein the material of the core body 5 is or comprises a copper sheet. The copper sheet comprises or consists of, for example, a copper alloy comprising at least 50 wt. % Cu. The copper sheet may be tin-plated.

For example, the core body 5 extends longitudinally from its first embedded portion 7 to its second embedded portion 8 along a longitudinal direction L of the busbar unit 4. The core body 5 extends transversely to the longitudinal direction L along the width direction B of the busbar unit 4. In the present case, the core body 5 at least partially has an in particular uniform core thickness K perpendicular to the longitudinal direction L and perpendicular to the width direction B. The core thickness K is, for example, 0.3 mm to 1.0 mm, in particular 0.5 mm.

In the present case, the busbar unit 4 is at least partially flat or planar. The at least partially flat busbar unit 4 at least partially rests against the battery cell pack 2.

The battery pack 1 has, for example, a substantially generally cylindrical, in particular prismatic, in the present case cuboidal shaping. In the present case, the longitudinal direction L extends from a substantially rectangular bottom side to a substantially rectangular top side, situated opposite the bottom side, of the battery pack 1. “Substantially rectangular” relates to the fact that, for example, corners of the bottom side and/or of the top side may be rounded. A maximum width of the busbar unit 4 is, for example, smaller than the width of the sides 22, 23 of the battery pack 1.

In the present case, the stabilization body 6 at least partially has a thickness 1 perpendicular to the longitudinal direction L and perpendicular to the width direction B. The thickness 1 is for example 1 to 5 times, in particular 3 times, the core thickness K of the core body 5. A layer thickness S of the material of the stabilization body 6 on the embedded portions 7, 8 of the core body 5 is for example approximately the same as the core thickness K in absolute terms. In the bridge portion 10, the thickness 1 corresponds for example to a material thickness and in the embedded portions 7, 8 it is composed of the core thickness K and twice the layer thickness S.

For example, the fusible link portion 9 has a length of from 5 mm to 30 mm, for example 23 mm. A transition between a respective one of the embedded portions 7, 8 and the fusible link portion 9 may be rounded. The material of the core body 5 may be bare at the transition. The core body 5 may accordingly have a region on which the material of the core body 5 is bare and which comprises the transitions and the fusible link portion 9. The region may have a length of from 6 mm to 35 mm, in the present case 25 mm. The region may have a width of from 3 mm to 10 mm, in the present case 5 mm.

For example, at least one, in the present case each, of the embedded portions 7, 8 has at least one in particular lug- or tongue-shaped projection 12. The projection 12 protrudes into an intermediate space 13 of the core body 5, which intermediate space is present between the embedded portions 7, 8 and extends along the fusible link portion 9. The at least one, in the present case each, of the embedded portions 7, 8 has two projections 12, which are situated opposite one another along the width direction B of the busbar unit 4.

The embedded portions 7, 8 may act as a heat sink. The projection 12 may enhance the heat sink function of the embedded portions 7, 8. In addition, the projection 12, as component of the respective embedded portion 7, 8, may be embedded in the material of the stabilization body 6, so that a distance to be spanned by the bridge portion 10 between the embedded portions 7, 8 can be reduced by means of the projection 12. In this respect, the projection 12 may improve the support of the embedded portions 7, 8 with respect to one another that is brought about by the bridge portion 10.

The busbar unit 4 may have a pair of positioning projections 14 in the region of at least one of the two embedded portions 7, 8. The positioning projections 14 of the pair may be situated opposite one another along the width direction B of the busbar unit 4. In the present case, both of the embedded portions 7, 8 have such a pair of positioning projections 14. The positioning projections 14 are configured, for example, to align the busbar unit 4 and/or fix it in place relative to the battery cell pack 2 and—alternatively or additionally—relative to the connection device 3.

For example, a first contact portion 16, adjoining the first embedded portion 7, of the core body 5 is integrally bonded to the connection device 3. As an alternative or in addition, a second contact portion 17, adjoining the second embedded portion 8, of the core body 5 is integrally bonded to the battery cell pack 2 or to power electronics of the battery pack 1 that are electrically connected to the battery cell pack 2. The integral bond between the first contact portion 16 and the connection device 3 can be created by welding or soldering. The integral bond between the second contact portion 17 and the battery cell pack 2 or the power electronics of the battery pack 1 can be created by welding or soldering. The contact portions 16, 17 may, as in the present case, be angled relative to the longitudinal direction L, in order to engage around the battery cell pack 2, in particular at the top and the bottom.

For example, the electrically insulating material of the stabilization body 6 comprises or consists of an in particular flame-retardant plastic. As an alternative or in addition, the two embedded portions 7, 8 are peripherally coated with the plastic to embed them. As an alternative or in addition, the stabilization body 6 forms an injection-moulded encapsulation of the busbar unit 4, wherein the injection-moulded encapsulation surrounds the embedded portions 7, 8 of the core body 5.

In the present case, the embedded portions 7, 8 are peripherally coated with the plastic along a peripheral direction U of the busbar unit 4. The peripheral direction U extends in a plane stretching out perpendicularly in relation to the longitudinal direction L. A thickness direction D of the busbar unit 4 extends perpendicularly in relation to the longitudinal direction L and perpendicularly in relation to the width direction B.

The plastic, in particular its main component, may be selected from the group of polybutylene terephthalate (PBT), polyamide (PA) and polypropylene (PP). For example, the plastic is reinforced with glass fibers. For example, the plastic may comprise 20 to 40 wt. % glass fibers. In the present case, the plastic is a PBT GF 30, which is to say a polybutylene terephthalate comprising a glass fiber content of 30 wt. %.

In the present case, the bridge portion 10 projects away from the fusible link portion 9 along the width direction B of the busbar unit 4. For example, the bridge portion 10 projects along the width direction B by a magnitude of the free spacing A present between the fusible link portion 9 and the bridge portion 10 along the width direction B. The spacing A may be 1 mm to 10 mm, for example 1.5 mm.

In the present case, the busbar unit 4 of the battery pack 1 is produced by a method according to which the stabilization body 6 is made around the core body 5 by primary shaping. For example, the stabilization body 6 is made around the core body 5 or from a plastic by primary shaping. The core body 5 may be produced by casting a synthetic resin. As an alternative, the stabilization body 6 may be produced by dipping the core body 5 into a rubber dip bath of a rubber material. In principle, it is also conceivable to produce multiple insulating parts of the stabilization body 6 in advance by primary shaping, for example by injection moulding, and to adhesively bond them to one another for embedding arrangement on the core body 5.

For example, the stabilization body 6 is, however, injection moulded. The method may comprise a first step a), in which a closeable injection mould having a cavity is provided, wherein the cavity has a complementary negative contour to the shaping of the stabilization body 6. The method may also comprise a step b), in which the core body 5 is positioned in/on the open injection mould. This can be followed by a further step c) of the method, in which the injection mould is closed, in order to arrange, in particular clamp, the core body 5 inside the cavity of the injection mould in such a way that the fusible link portion 9 is masked. The method may furthermore comprise a step d), in which the stabilization body 6 is injection moulded, wherein the core body 5, apart from its fusible link portion 9, is encapsulated with the material of the stabilization body 6 by injection moulding, in order to embed the two embedded portions 7, 8 in the material of the stabilization body 6.

For example, temporally before carrying out step a), separating machining, for example in the form of punching, and shaping of the core body 5 can be performed.

The battery pack 1 according to the invention can be produced by electrically connecting its battery cell pack 2, or power electronics of the battery pack 1 that are electrically connected to the battery cell pack 2, to the connection device 3 of the battery pack 1 by means of the busbar unit 4 produced by the method explained above.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery pack for a battery device, comprising:
a battery cell pack for storing electrical energy;
a connection device for electrically connecting the battery pack to the battery device; and
at least one electrical busbar unit electrically connecting the battery cell pack to the connection device,
wherein the busbar unit has an electrically conductive core body and an electrically insulating stabilization body comprising electrically insulating material,
wherein the core body has a first embedded portion, which is nearer the connection device, and a second embedded portion, which is remote from the first embedded portion,
wherein the core body has a fusible link portion of reduced cross section relative to the first and second embedded portions, which fusible link portion electrically and mechanically connects the first and second embedded portions to one another,
wherein the first and second embedded portions are each embedded in the electrically insulating material of the stabilization body, and
wherein the stabilization body has at least one bridge portion, which extends at a spacing from the fusible link portion between the first and second embedded portions, in order to mechanically support the first and second embedded portions with respect to one another in addition to their connection by way of the fusible link portion.

2. The battery pack according to claim 1,
wherein an electrically conductive material of the core body is exposed at the fusible link portion.

3. The battery pack according to claim 2,
wherein the core body is in the form of a sheet-metal part comprising copper.

4. The battery pack according to claim 1,
wherein the core body extends longitudinally from the first embedded portion to the second embedded portion along a longitudinal direction of the busbar unit,
wherein the core body extends transversely to the longitudinal direction along a width direction of the busbar unit,
wherein the core body has a core thickness perpendicular to the longitudinal direction and perpendicular to the width direction, wherein the core thickness is 0.3 mm to 1.0 mm, or is 0.5 mm.

5. The battery pack according to claim 1,
wherein the busbar unit is at least partially flat and at least partially rests against the battery cell pack.

6. The battery pack according to claim 4,
wherein the stabilization body has a thickness perpendicular to the longitudinal direction and perpendicular to the width direction, which thickness is 1 to 5 times, or is 3 times, the core thickness.

7. The battery pack according to claim 1,
wherein the stabilization body has two bridge portions, which are situated opposite one another along a width direction of the busbar unit, in order to flank the fusible link portion at a mutual spacing,
wherein the fusible link portion connects the first and second embedded portions to one another transversely to the width direction.

8. The battery pack according to claim 1,
wherein at least one of the first and second embedded portions has at least one lug- or tongue-shaped projection, which projection protrudes into an intermediate space of the core body, which intermediate space is present between the first and second embedded portions and extends along the fusible link portion.

9. The battery pack according to claim 8,
wherein the at least one of the first and second embedded portions has two projections, which are situated opposite one another along a width direction of the busbar unit.

10. The battery pack according to claim 1,
wherein, in a region of at least one of the first and second embedded portions, the busbar unit has a pair of positioning projections, which are situated opposite one another along a width direction of the busbar unit.

11. The battery pack according to claim 10,
wherein the positioning projections are configured to align the busbar unit and/or fix the busbar unit in place relative to the battery cell pack and/or relative to the connection device.

12. The battery pack according to claim 1,
wherein a first contact portion, adjoining the first embedded portion, of the core body is integrally bonded to the connection device, and/or
wherein a second contact portion, adjoining the second embedded portion, of the core body is integrally bonded to the battery cell pack or to power electronics of the battery pack that are electrically connected to the battery cell pack.

13. The battery pack according to claim 1, wherein at least one of:
the electrically insulating material of the stabilization body is or comprises plastic,
the first and second embedded portions are peripherally coated with plastic to embed them, or
the stabilization body forms an injection-molded encapsulation of the busbar unit, which injection-molded encapsulation surrounds the first and second embedded portions of the core body.

14. The battery pack according to claim 1,
wherein the bridge portion projects away from the fusible link portion along a width direction of the busbar unit, by a magnitude of a free spacing present along the width direction between the fusible link portion and the bridge portion.

15. The battery pack according to claim 1,
wherein the battery pack has two structurally identical busbar units, which are situated on opposite sides of the battery pack, in order to flank the battery cell pack; and/or
wherein the battery pack has an additional electrical fuse device that is redundant with respect to the fusible link portion, wherein the additional electrical fuse device has an electronic circuit breaker.

16. A system, comprising:
a battery device; and
at least one battery pack according to claim 1;
wherein the battery pack is electrically connected exchangeably to the battery device, in order to supply electrical energy to the battery device and/or draw electrical energy from the battery device.

17. A method for producing a busbar unit for a battery pack, the method comprising:
primary forming an electrically insulating stabilization body around an electrically conductive core body with or from plastic in order to produce the busbar unit, wherein
wherein the core body has a first embedded portion and a second embedded portion remote from the first embedded portion,
wherein the core body has a fusible link portion of reduced cross section relative to the first and second embedded portions, which fusible link portion electrically and mechanically connects the first and second embedded portions to one another,
wherein the first and second embedded portions are each embedded in the electrically insulating material of the stabilization body, and
wherein the stabilization body has at least one bridge portion, which extends at a spacing from the fusible link portion between the first and second embedded portions, in order to mechanically support the first and second embedded portions with respect to one another in addition to their connection by way of the fusible link portion.

18. The method according to claim 17, further comprising:
a) providing a closeable injection mold having a cavity, wherein the cavity has a complementary negative contour to a shaping of the stabilization body;
b) positioning the core body on/in the open injection mold;
c) closing the injection mold in order to arrange the core body inside the cavity of the injection mold in such a way that the fusible link portion is masked;
d) injection molding the stabilization body, wherein the core body, apart from its fusible link portion, is encapsulated with the material of the stabilization body by the injection molding, in order to embed the first and second embedded portions in a material of the stabilization body.
